(19) United States
(12) Patent Application Publication
(10) Pub. No.: US 2008/0240848 A1
(43) Pub. Date: Oct. 2, 2008

(54) Multiple axis movement yoke/clevis design (articulated clevis)

(76) Inventors: Mark C. Rauschert, Bushnell, IL (US); Scott A. Schauble, (US)

Correspondence Address: Midwest Control Products Inc., 590 E. Main St., Bushnell, IL, 61422, US

(21) Appl. No.: 11/787,263

(22) Filed: Mar. 28, 2007

(51) Int. Cl. F16D 3/00; F16C 11/00

(52) U.S. Cl. 403/122; 403/79; 403/53

(57) ABSTRACT

A Multiple Axis Movement Yoke/Clevis Design (Articulated Clevis) provides a means of axial movement, within a clevis design, while transmitting force between two locations. The articulated clevis allows for a more direct linear arrangement within a linkage connection.

### CROSS REFERENCE TO RELATED APPLICATIONS

Not Applicable

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

The invention relates to mechanical linkages such as cables, control assemblies, or rod assemblies that transfer motion from one location to another. More directly the invention relates to linkages where offsets, rotational bends, and axial play are required.

### BACKGROUND OF THE INVENTION

Different mechanisms within machines and vehicles utilize rigid or flexible linkage assemblies. Rigid linkage assemblies are solid rods or tubes connecting two points within a mechanical device. Flexible linkage assemblies are push-pull cables connecting two points within a mechanical device.

Linkage assemblies provide an actuation between two points by utilizing either a flexible or rigid body in conjunction with end connectors such as clevises, ball joints, swivels, or spherical rod ends. The end connectors are typically threaded onto the opposing ends of the linkage assembly whether it is a rigid or flexible design.

Certain applications require end connectors to allow for axial or rotational movement. While the ball joint (FIG. 4) allows for axial and rotational movement it does not maintain the same end connecting method as the clevis (FIG. 3). Certain mechanical linkage assemblies require the use of a clevis (FIG. 3) for attachment to an actuation or connection point. In this situation the use of both a ball joint and clevis body will be required to complete the connection. FIG. 2 illustrates such a design. Another solution to the before mentioned would be the utilization of a clevis (FIG. 3), threaded rod 5, and ball joint (FIG. 4) in conjunction. FIG. 1 illustrates such a design. The clevis body would be attached to the actuation point while the ball joint would be attached to the secondary point with the threaded body connecting both. Both designs require the use of the clevis and balljoint used in conjunction with one another to achieve axial movement.

### BRIEF SUMMARY OF THE INVENTION

The present invention (FIG. 5), an articulated clevis, is utilized for applications requiring rotational/axial movement while utilizing a clevis body. One advantage of this design is that it allows for axial movement within a direct linkage assembly therefore providing a greater allowance of offset.

The present invention may also be utilized in conjunction with a push-pull cable for actuating a mechanical device. Again the design allows for rotational/axial movement while utilizing a clevis body. In this example it eliminates pinch points and allows for uninterrupted travel within confined mechanical spaces.

Another aspect of the invention allows a rigid linkage to be utilized in place of a push-pull cable design. The articulated clevis would be utilized for connecting rigid linkage components while allowing for offsets and rotation within the linkage therefore acting in a similar manner to that of a push-pull cable.

### BRIEF DESCRIPTION OF THE DRAWINGS

FIG. 1 is a three dimensional view illustrating a linkage assembly with ball joint and clevis end connectors as known in prior art.

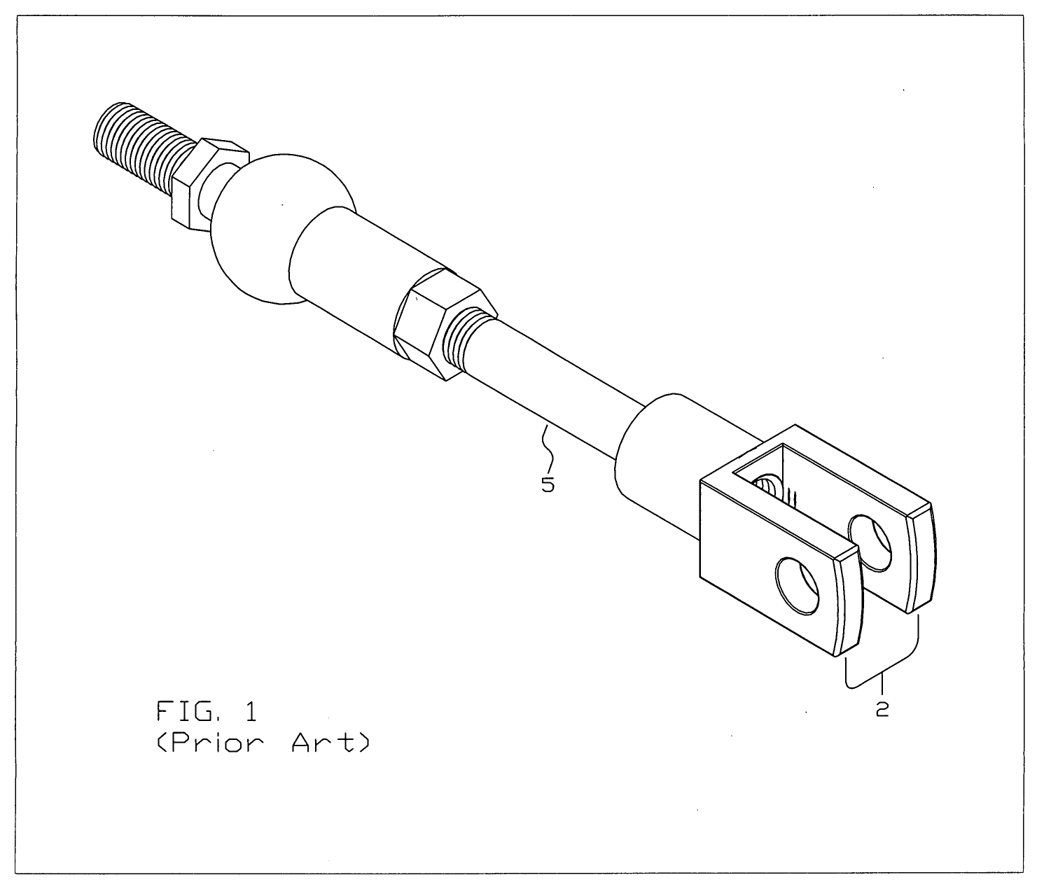

FIG. 1A is a three dimensional partial sectional view illustration of FIG. 1 linkage assembly as known in prior art.

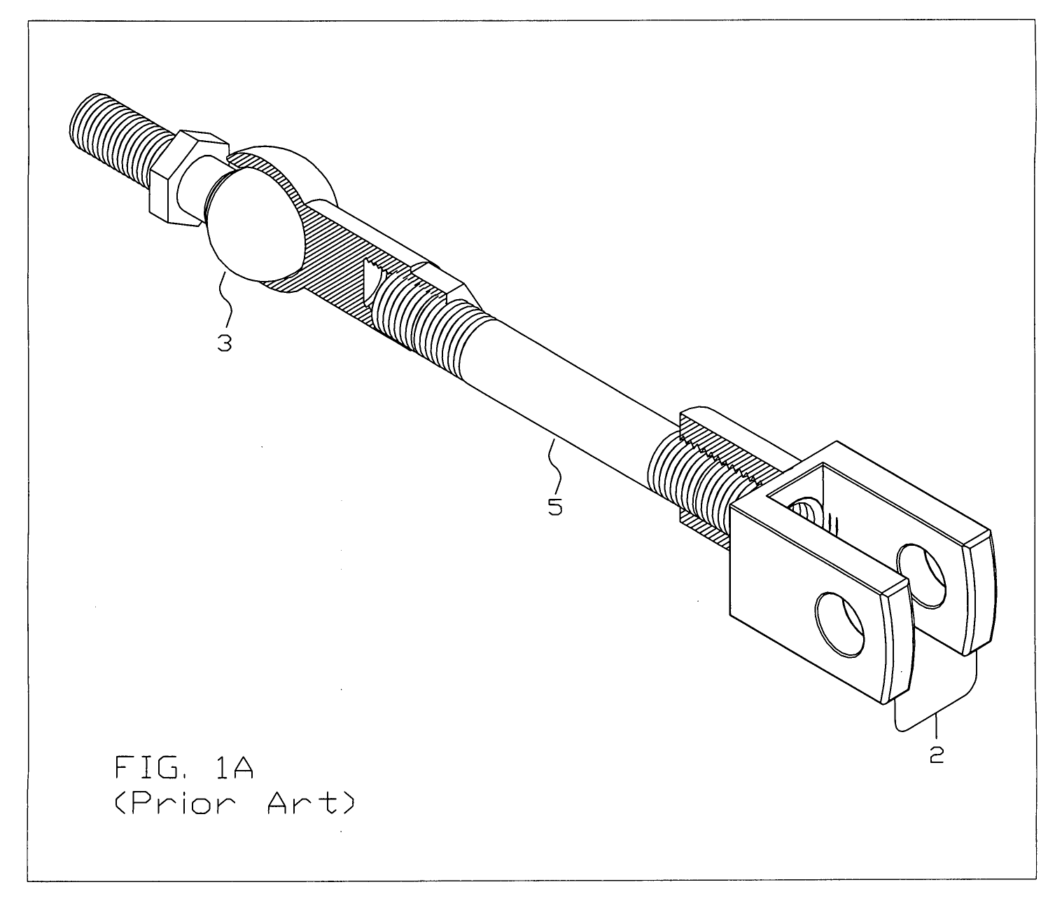

FIG. 1B is a partial sectional front view illustration of FIG. 1 linkage assembly as known in prior art.

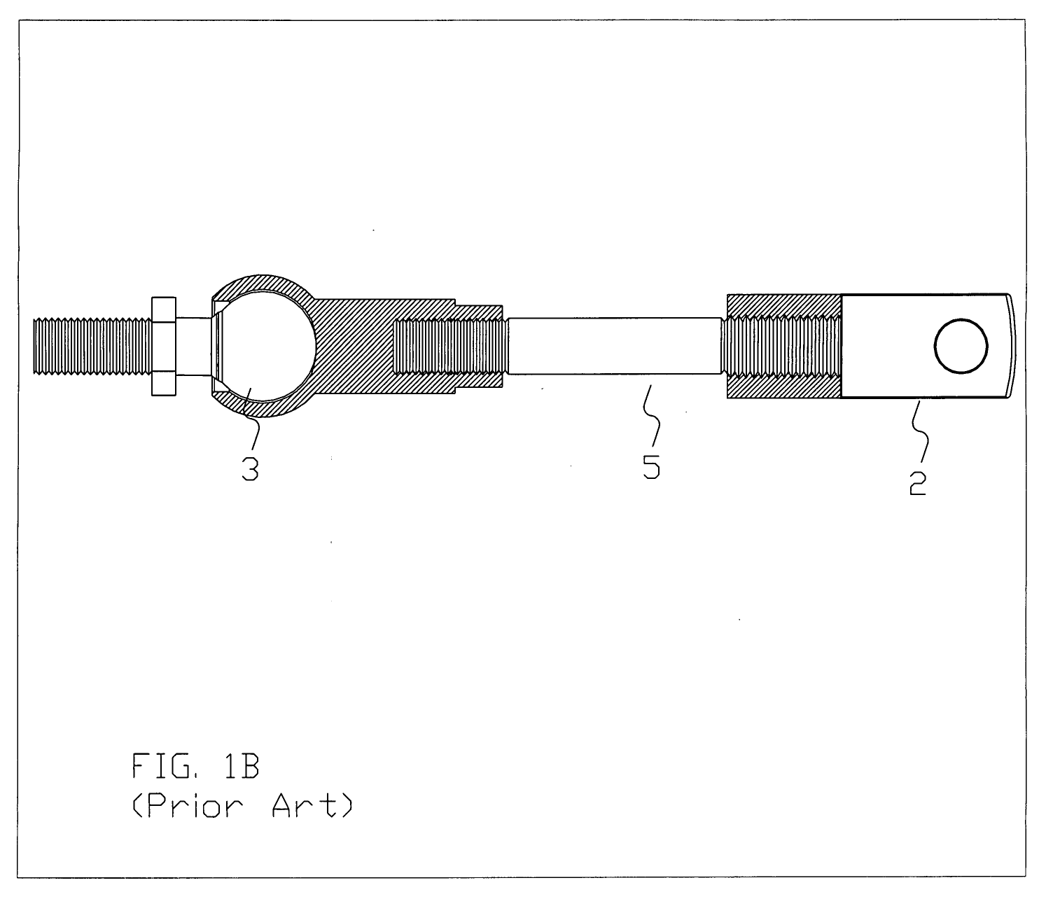

FIG. 1C is an exploded partial sectional front view illustration of FIG. 1 linkage assembly as known in prior art.

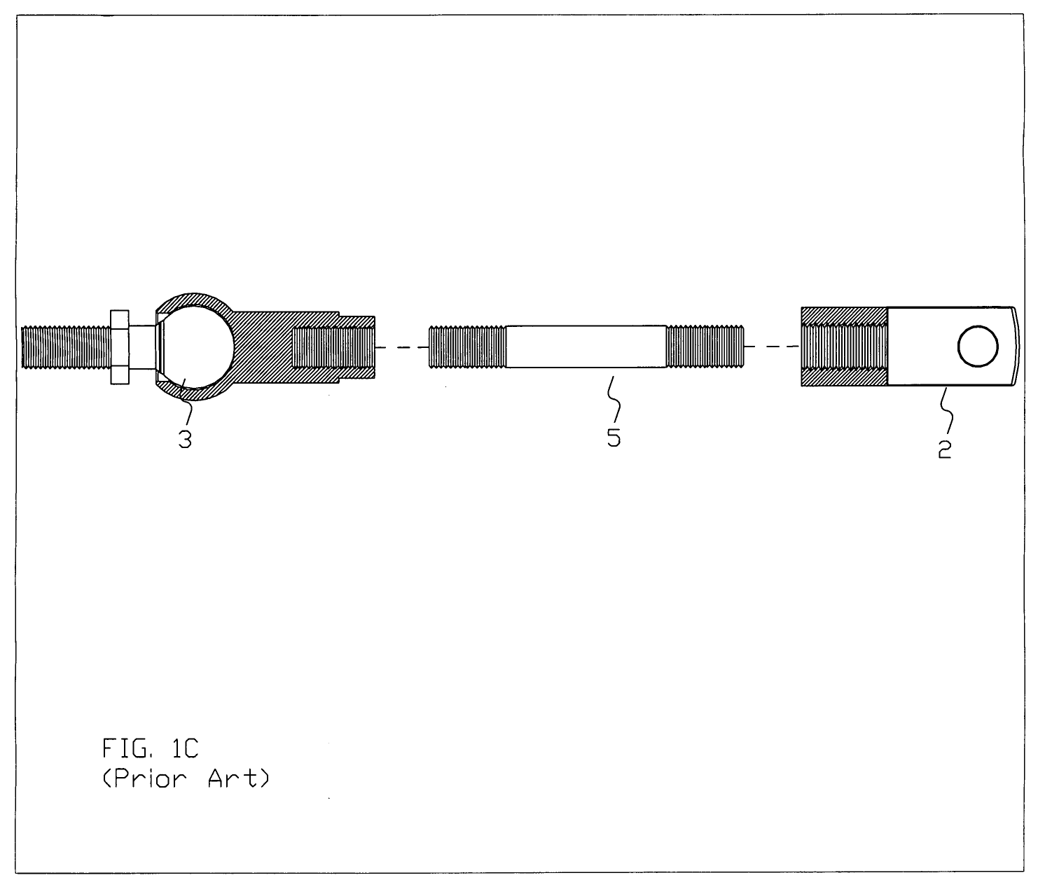

FIG. 2 is a three dimensional view illustrating another linkage assembly with ball joint and clevis end connectors making up the entire assembly as know in prior art.

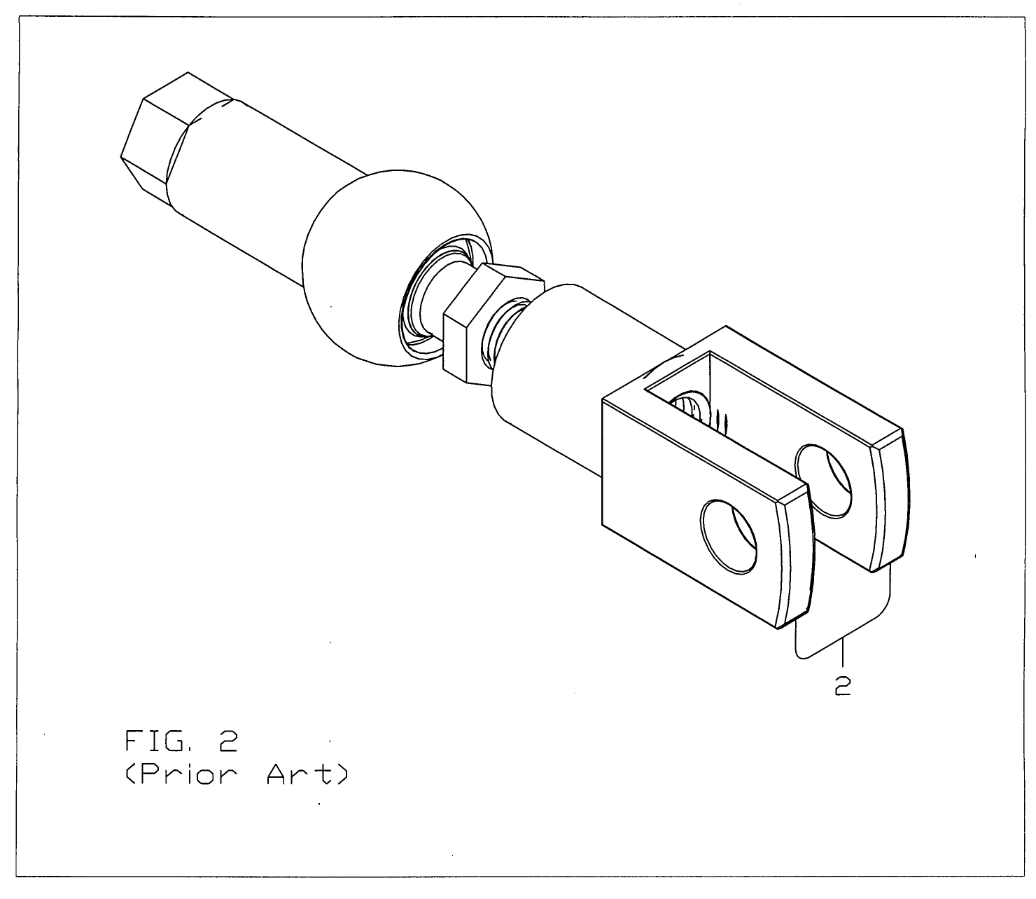

FIG. 2A is a three dimensional partial sectional view illustration of FIG. 2 linkage assembly as known in prior art.

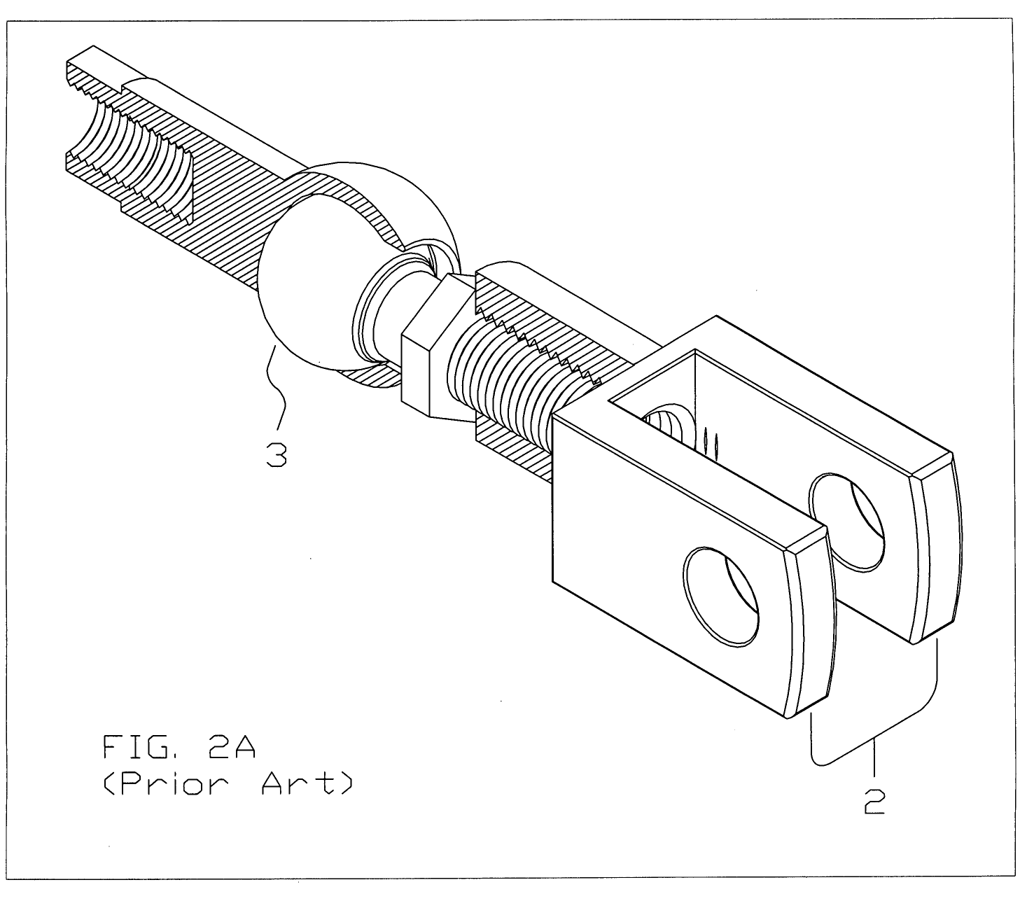

FIG. 2B is a partial sectional front view illustration of FIG. 2 linkage assembly as known in prior art.

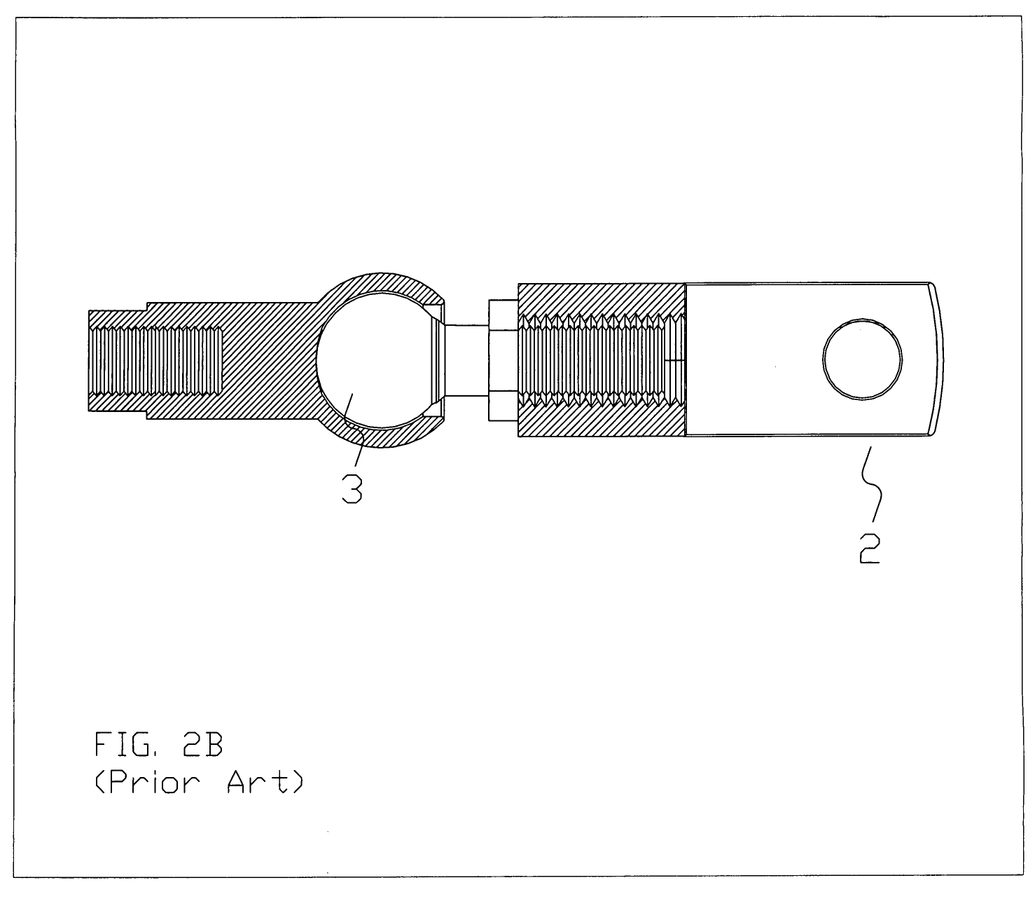

FIG. 2C is an exploded partial sectional front view illustration of FIG. 2 linkage assembly as known in prior art.

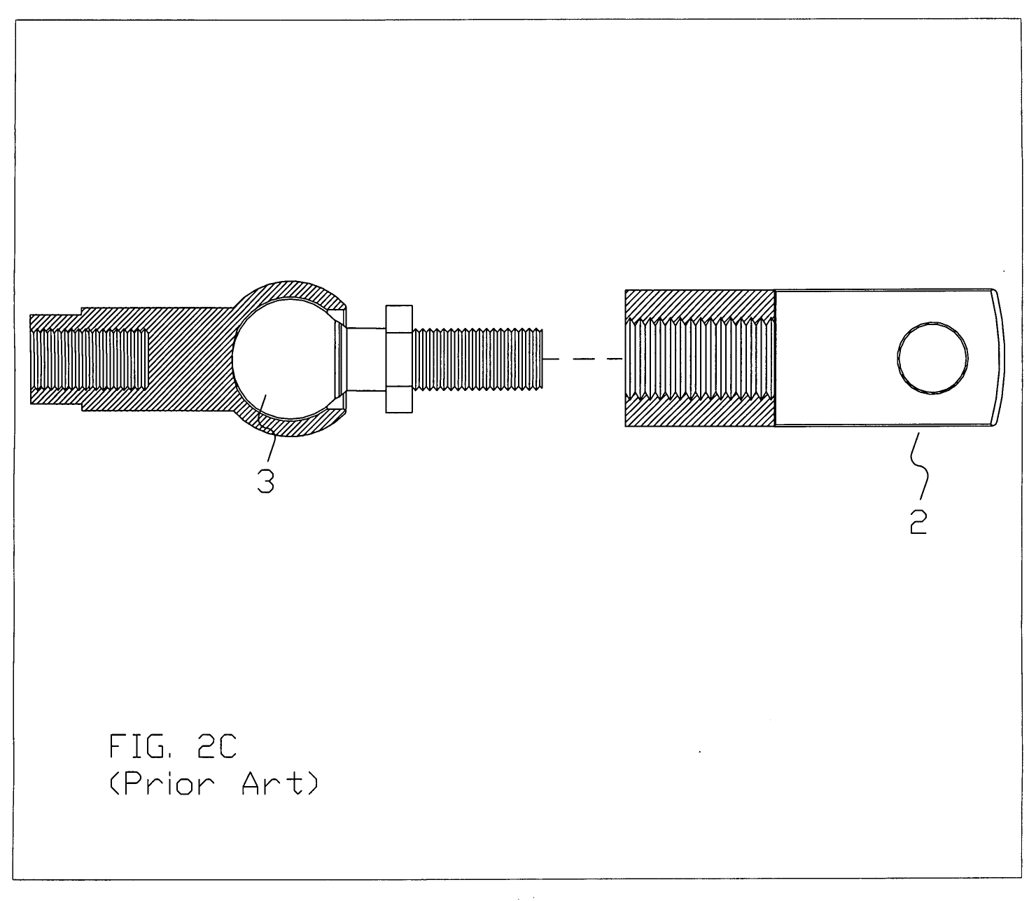

FIG. 3 is a three dimensional view illustrating a clevis linkage component as known in prior art.

FIG. 3A is a three dimensional partial sectional view illustration of FIG. 3 clevis linkage component as known in prior art.

FIG. 3B is a partial sectional front view illustration of FIG. 3 clevis linkage component as known in prior art.

FIG. 4 is a three dimensional partial sectional view illustrating a ball joint linkage component as known in prior art.

FIG. 4A is a three dimensional view illustration of FIG. 4 ball joint linkage component as known in prior art.

FIG. 4B is a partial sectional front view illustration of FIG. 4 ball joint linkage component as known in prior art.

FIG. 4C is an exploded partial sectional front view illustration of FIG. 4 ball joint linkage component as known in prior art.

FIG. 5 is a three dimensional view of a linkage component in accordance with the present invention.

FIG. 5A is a three dimensional partial sectional view of FIG. 5 linkage component in accordance with the present invention.

FIG. 5B is a partial sectional front view illustration of FIG. 5 linkage component in accordance with the present invention.

FIG. 5C is an exploded partial sectional front view of FIG. 5 linkage component in accordance with the present invention.

FIG. 5D is an exploded partial sectional top view of FIG. 5 linkage component in accordance with the present invention.

FIG. 6 is a three dimensional view of a linkage assembly in accordance with the present invention.

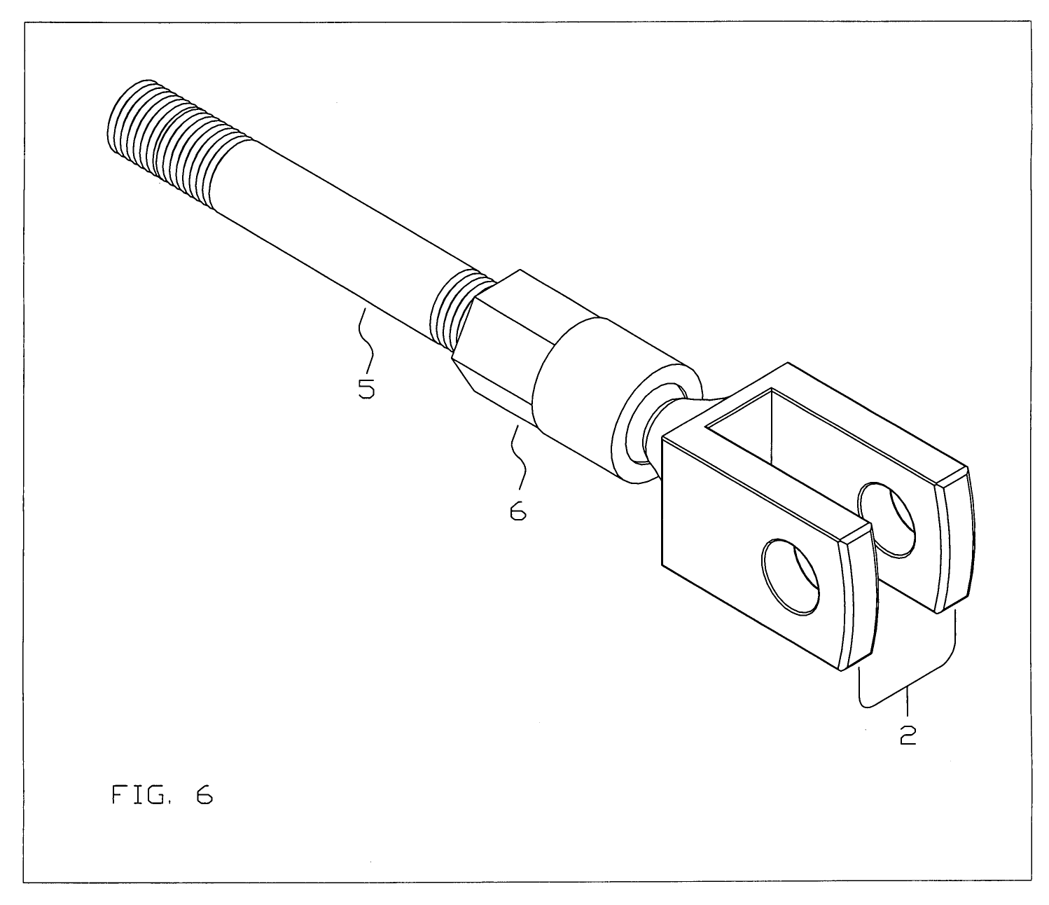

FIG. 6A is a three dimensional partial sectional view of FIG. 6 linkage assembly in accordance with the present invention.

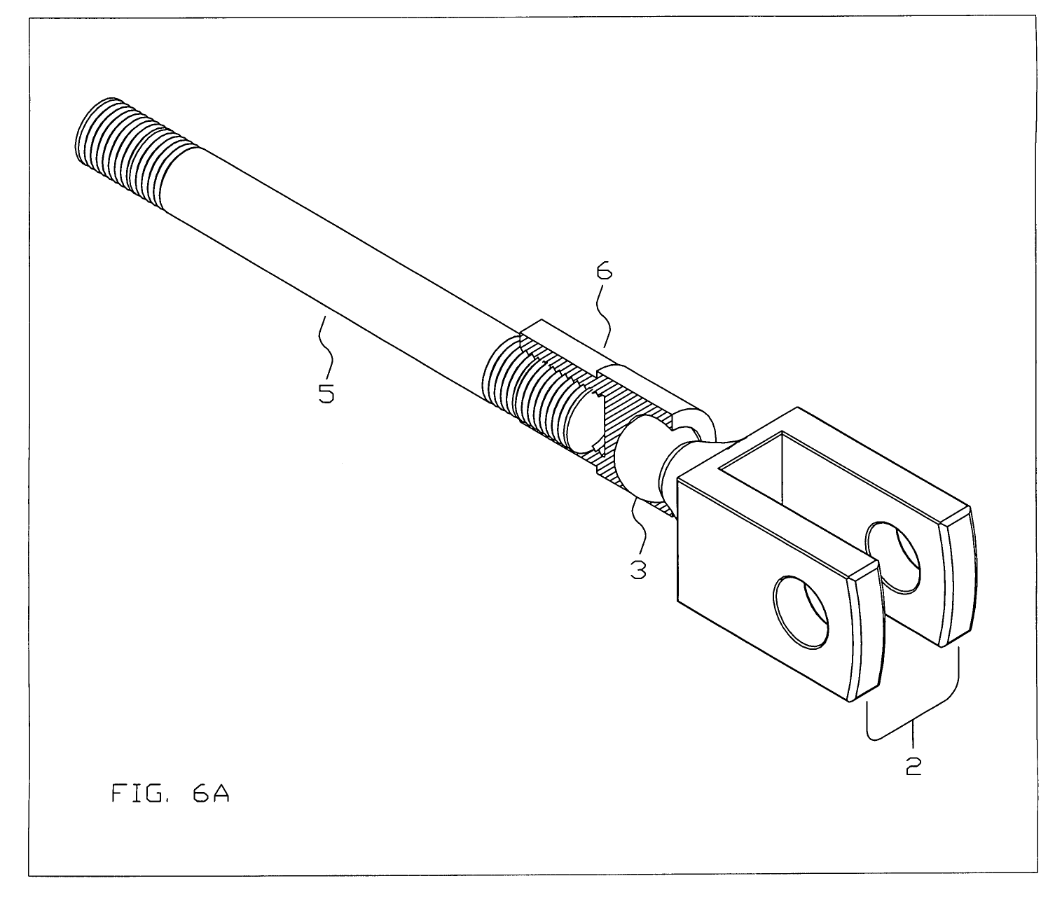

FIG. 6B is a partial sectional front view illustration of FIG. 6 linkage assembly in accordance with the present invention.

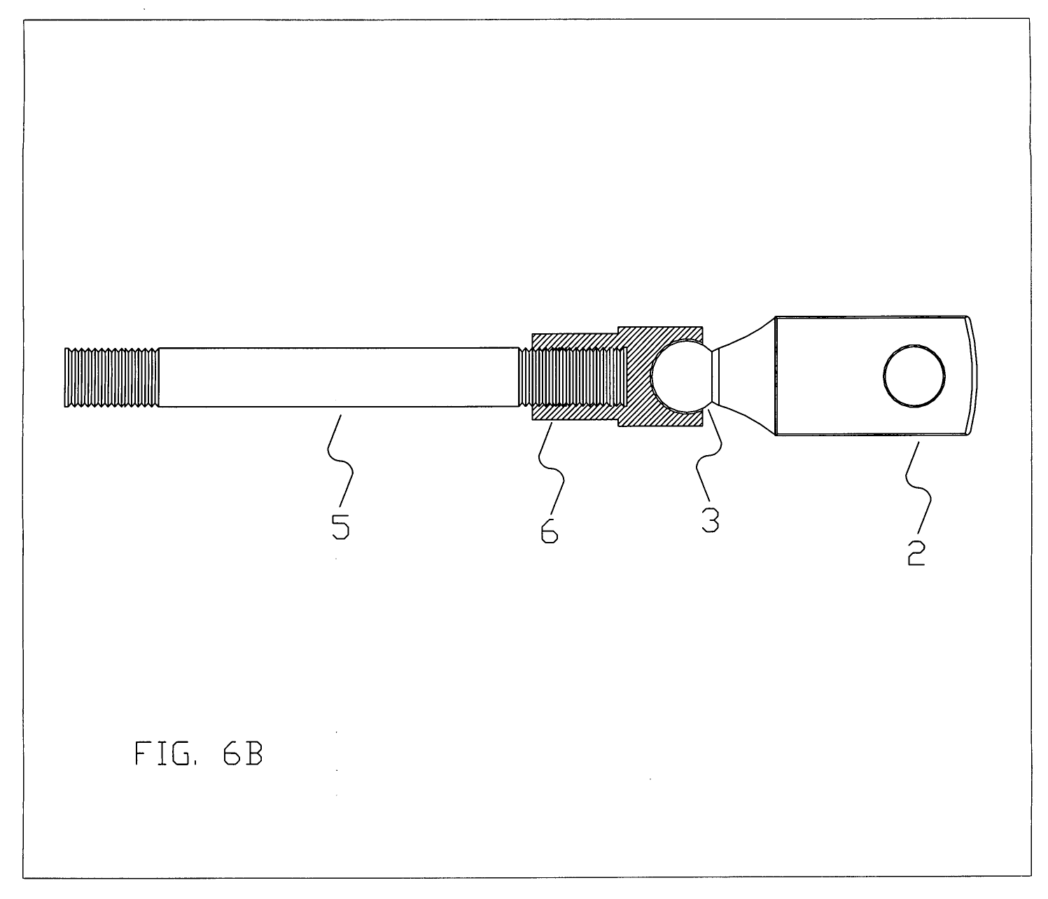

FIG. 6C is an exploded partial sectional front view illustration of FIG. 6 linkage assembly in accordance with the present invention.

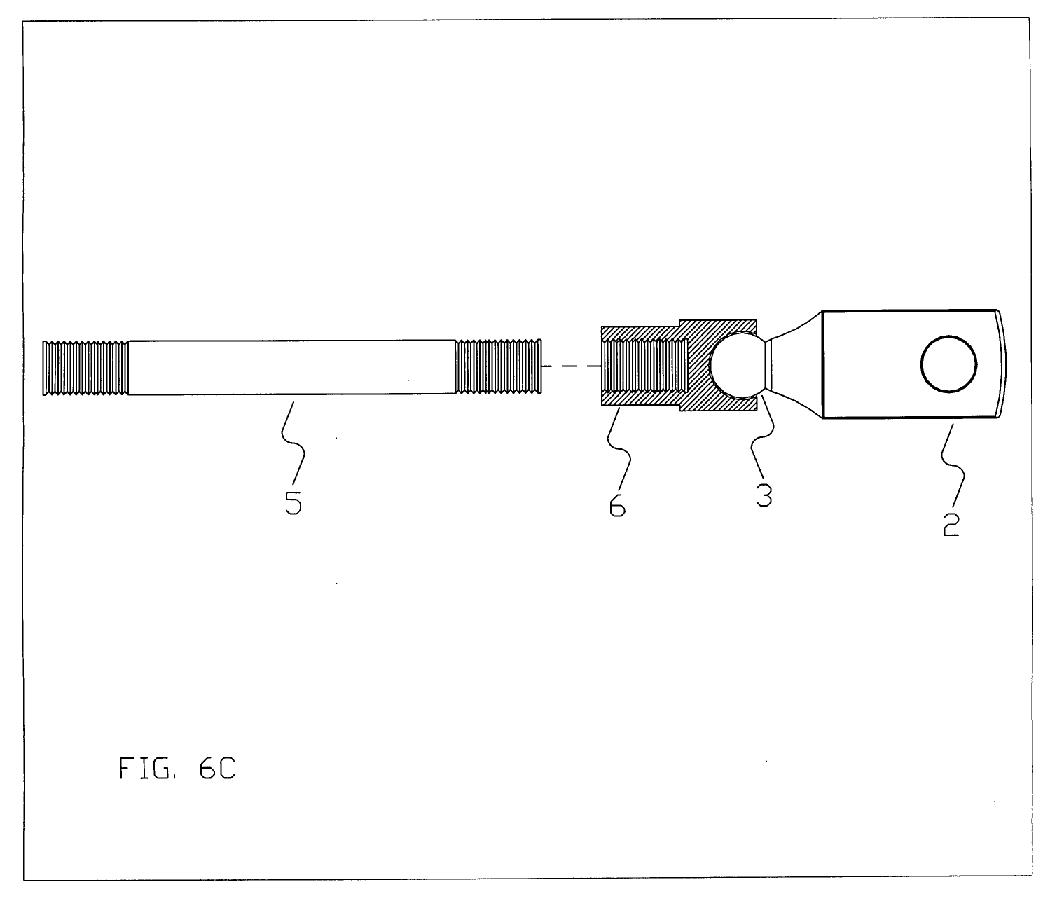

### DETAILED DESCRIPTION OF THE INVENTION

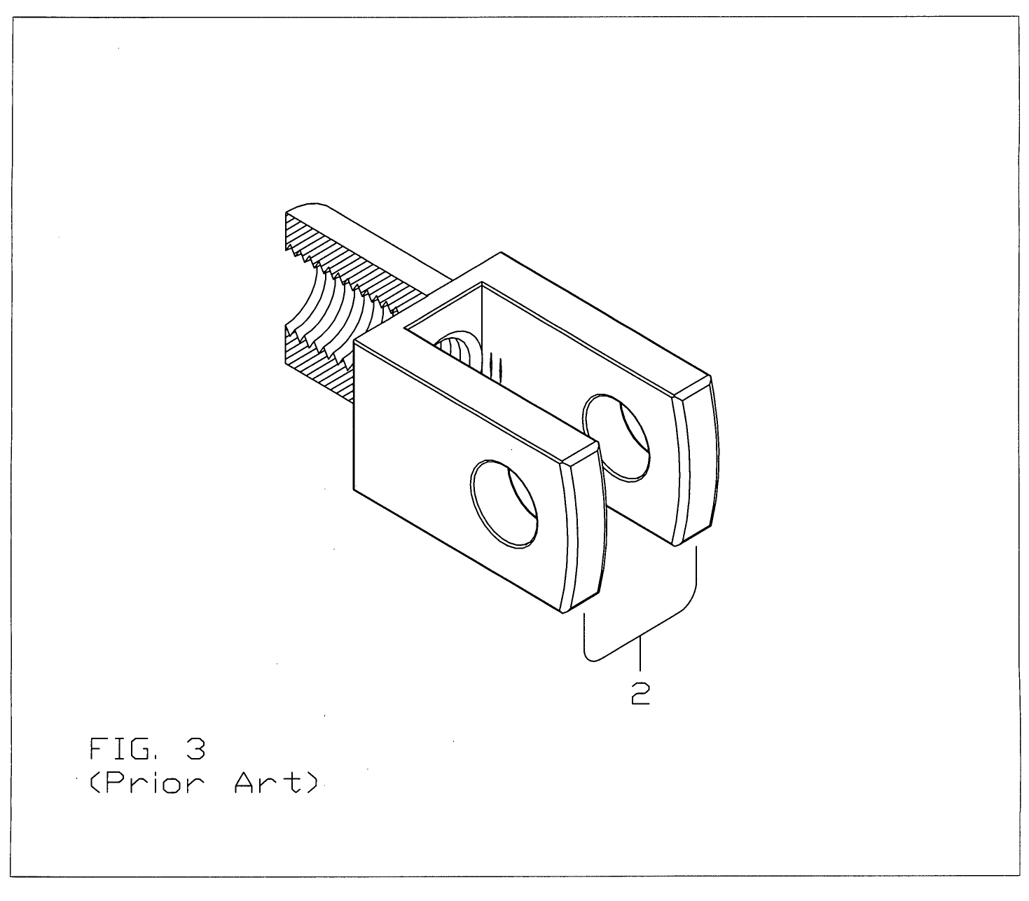

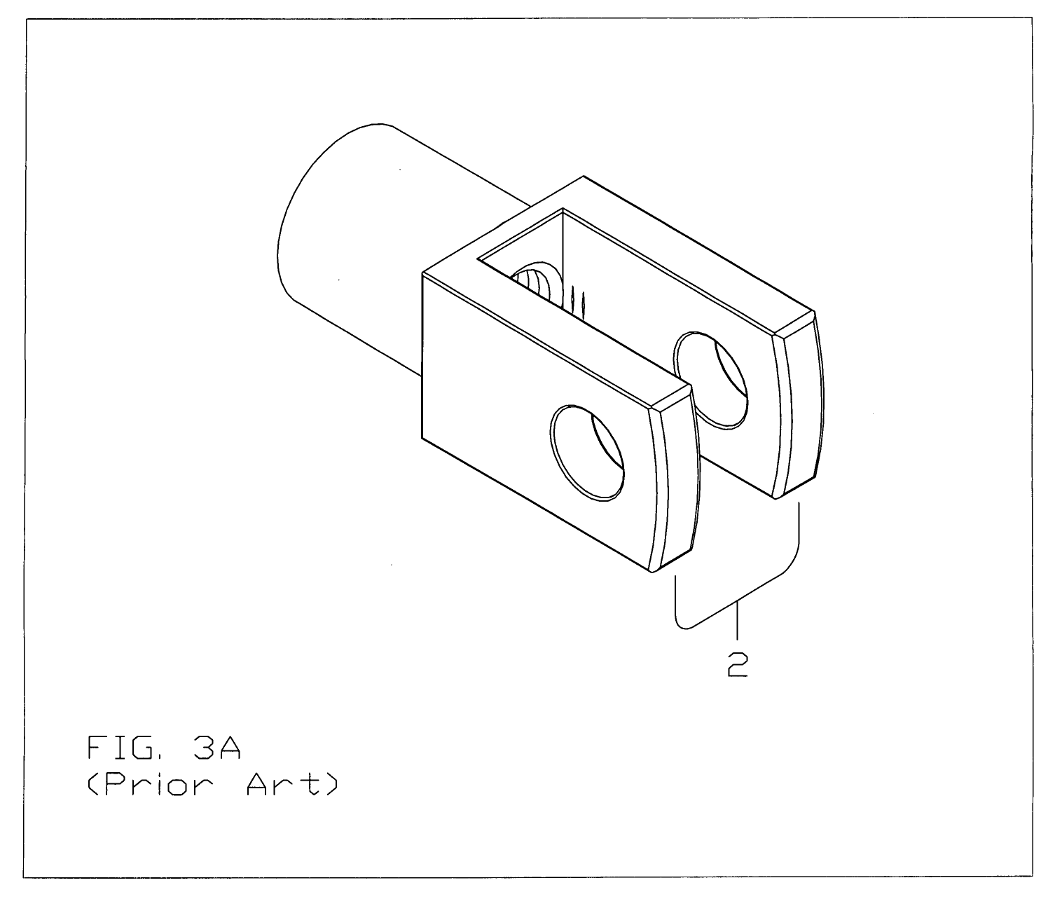

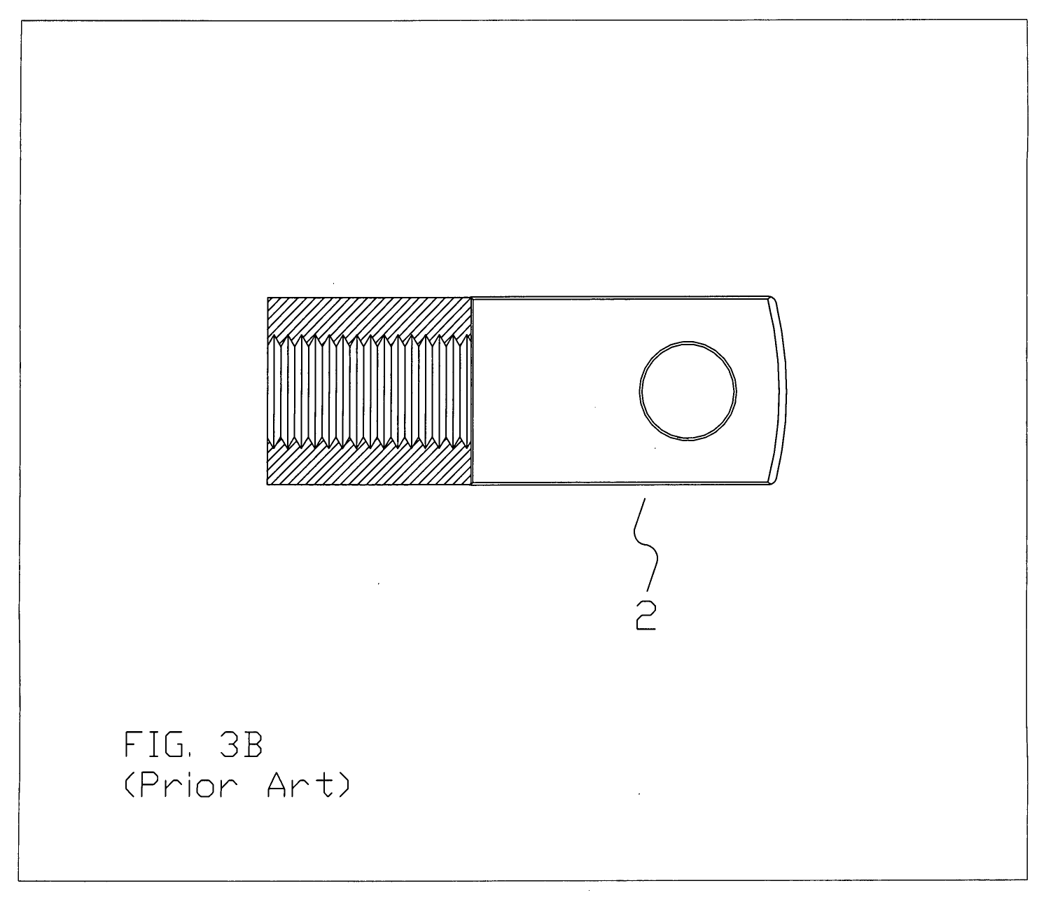

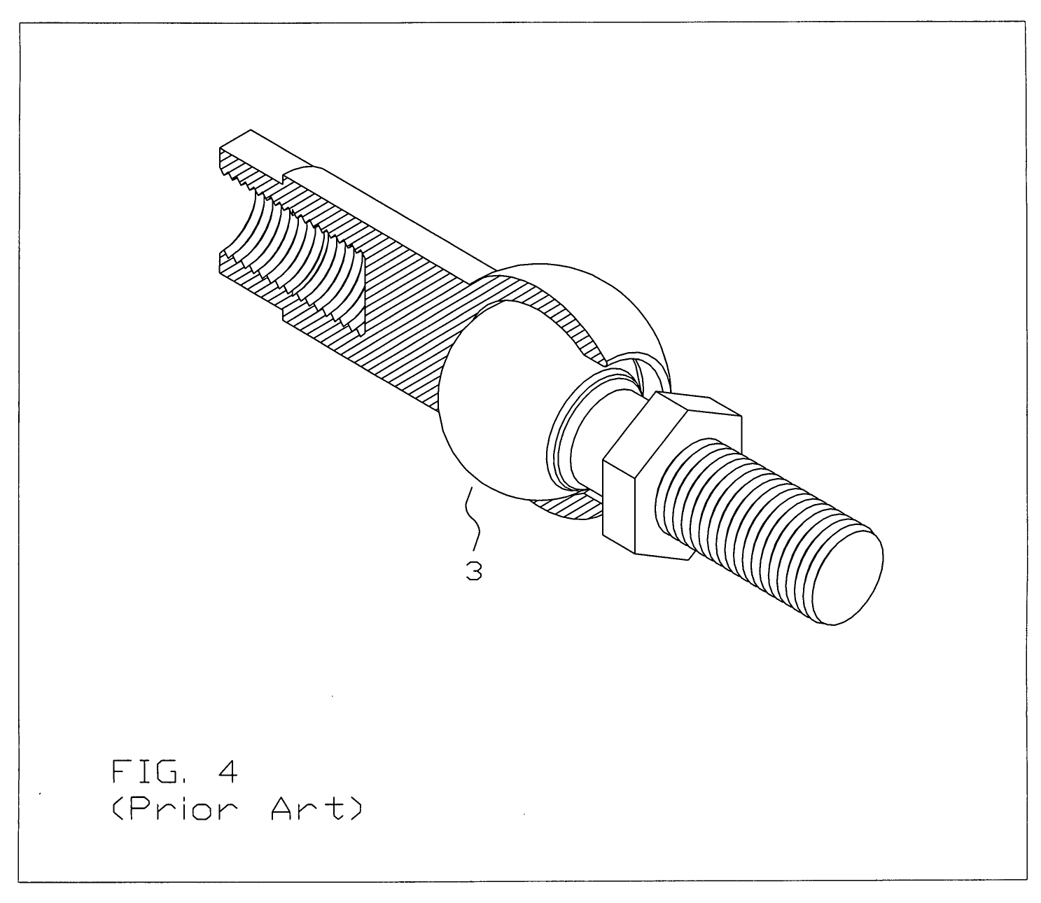

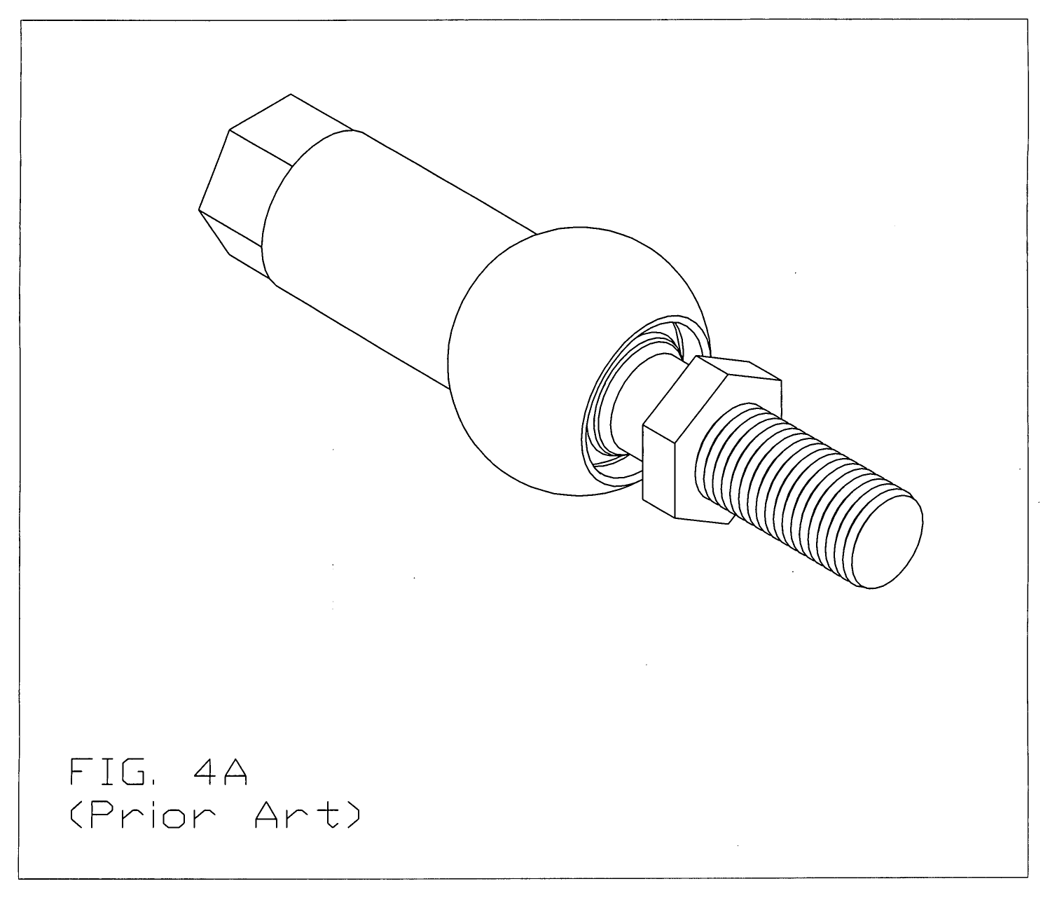

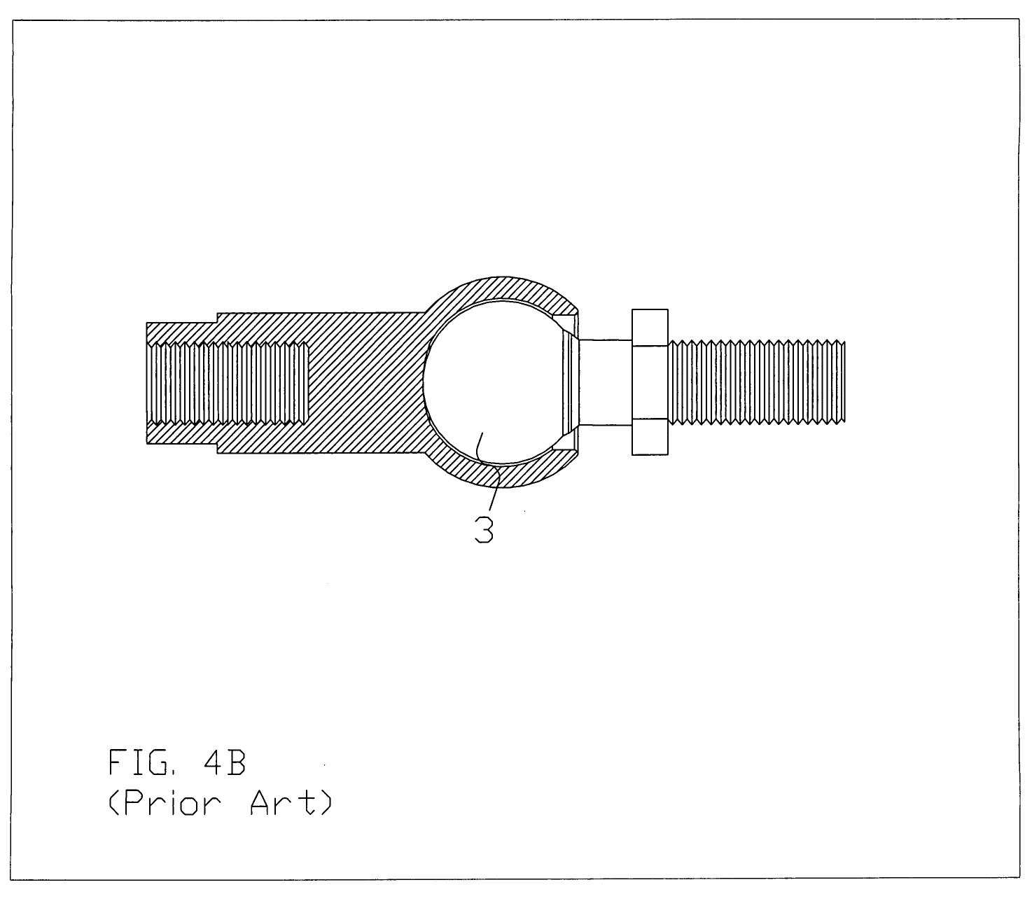

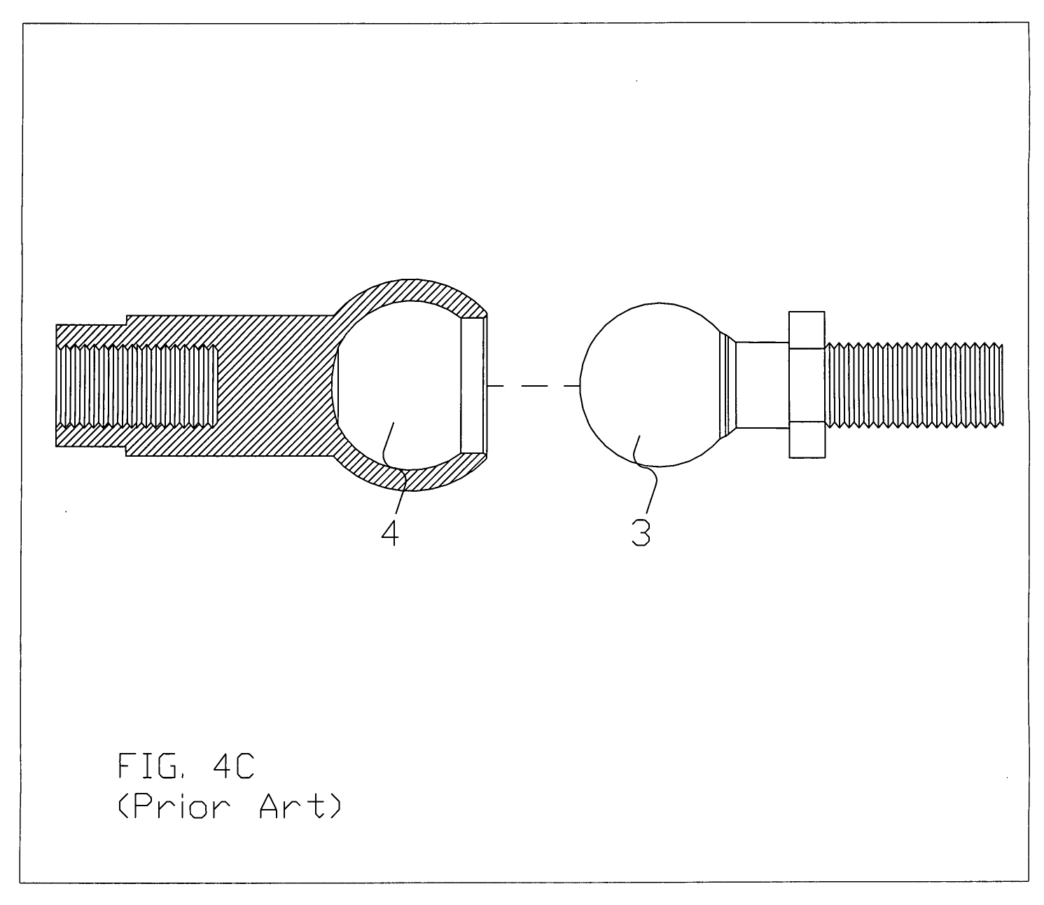

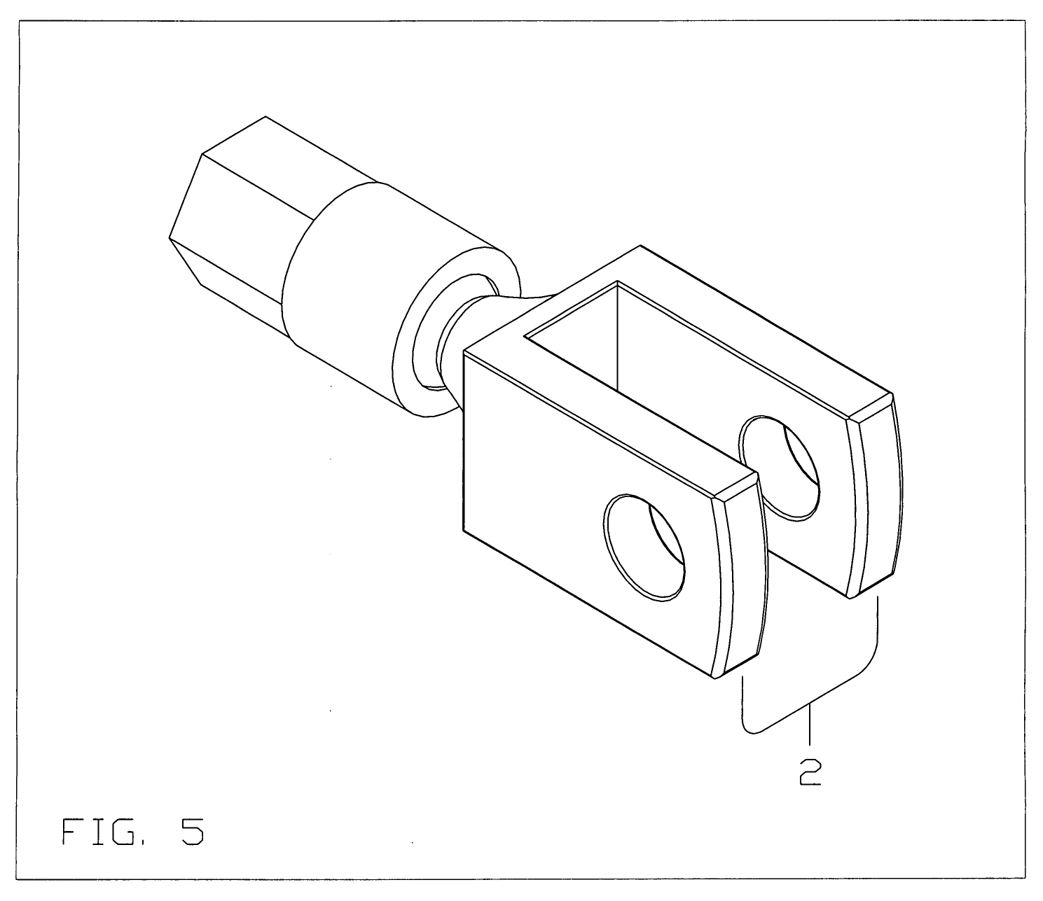

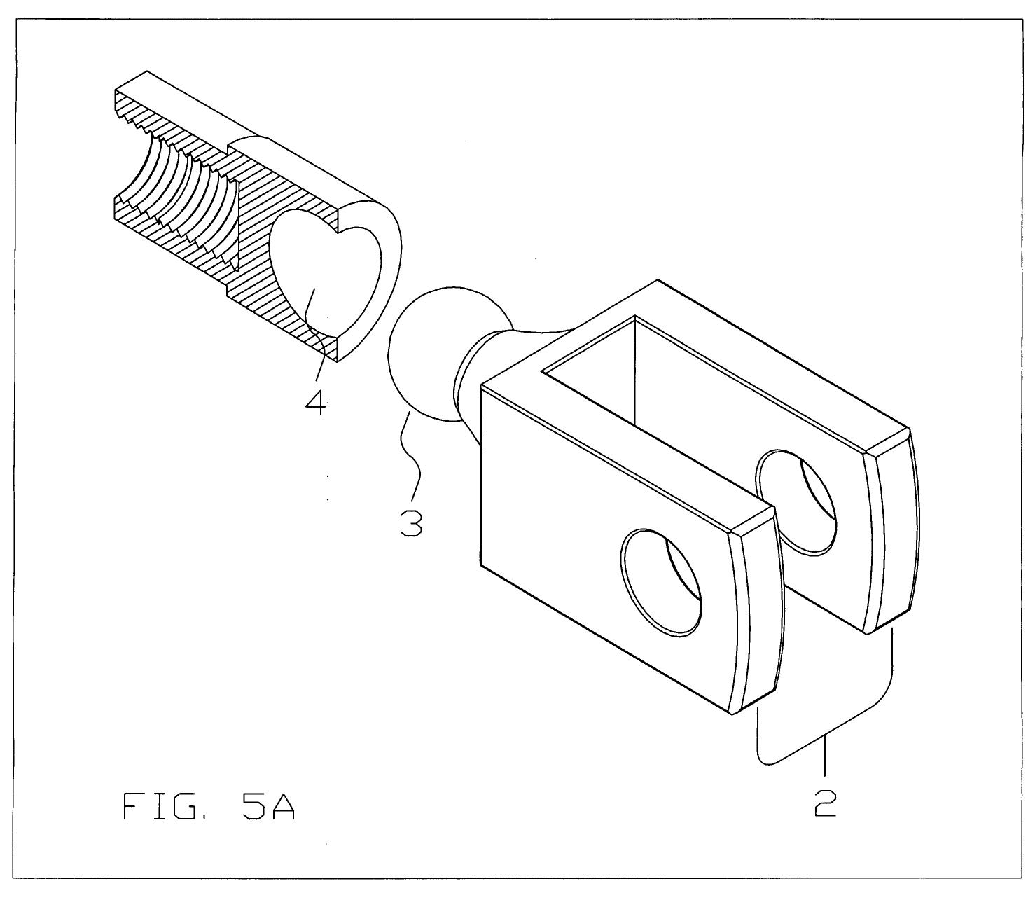

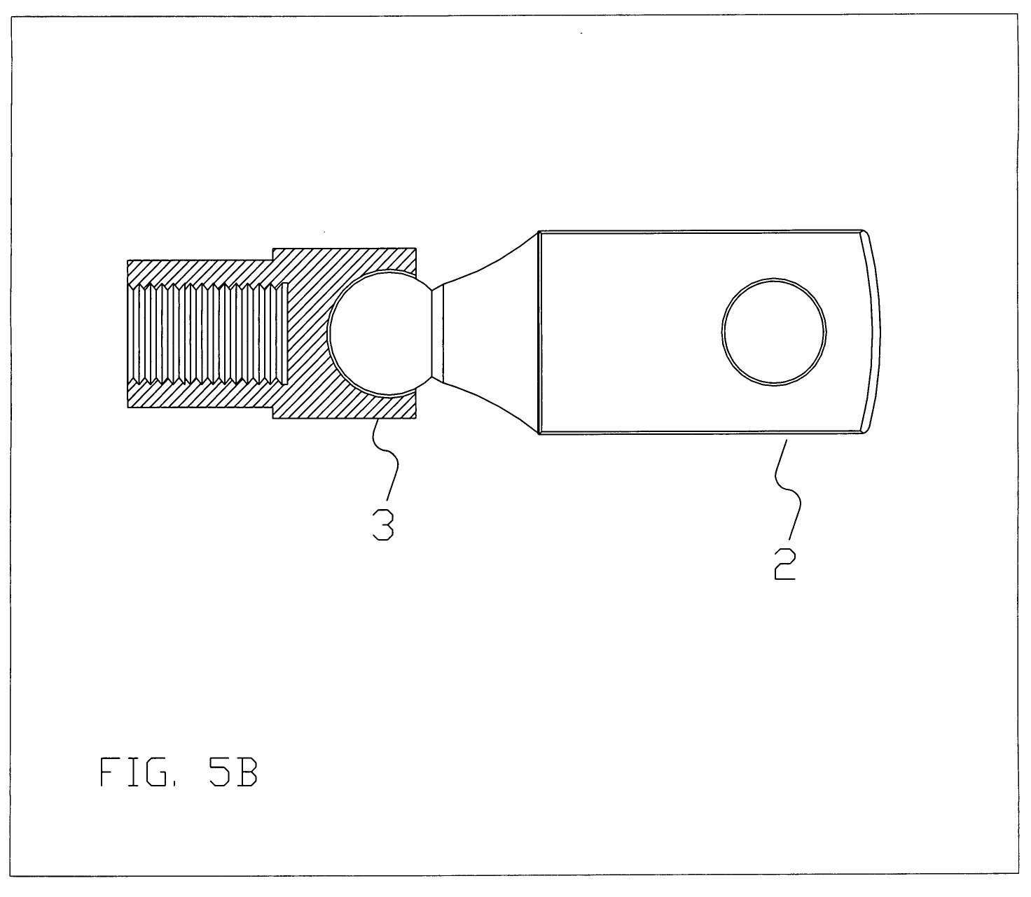

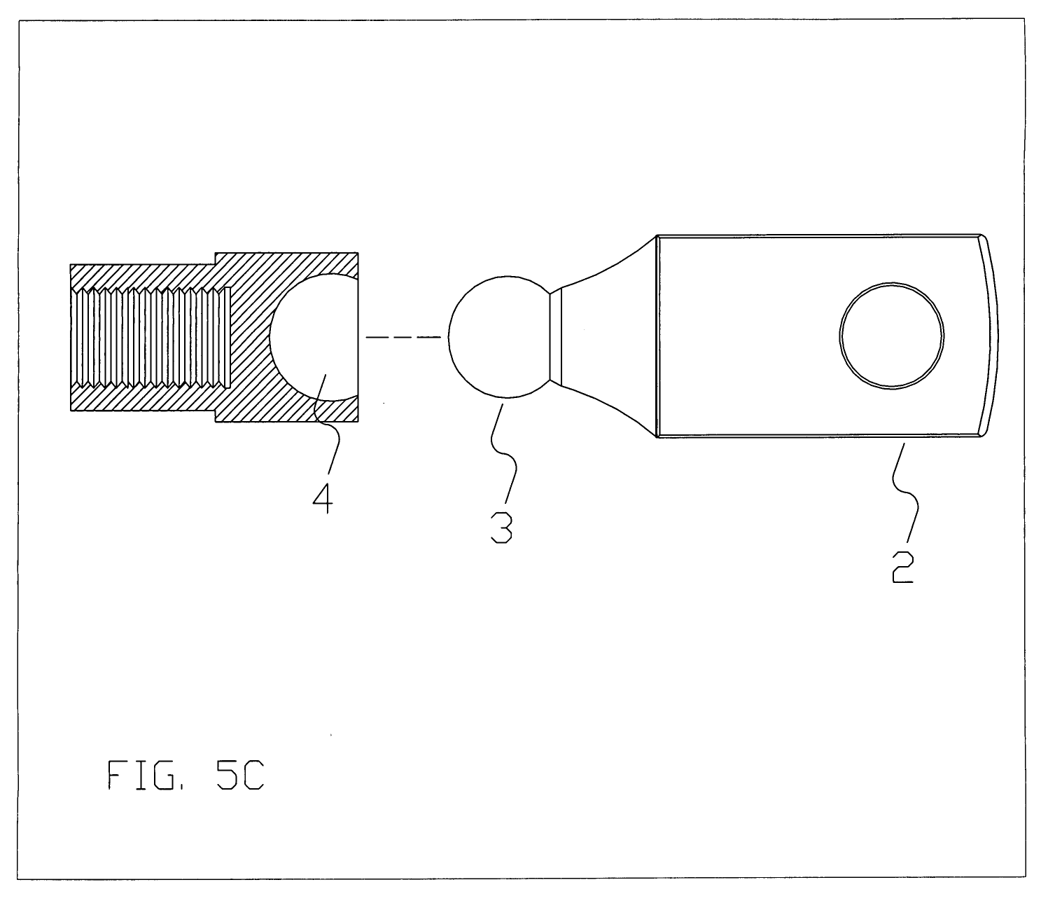

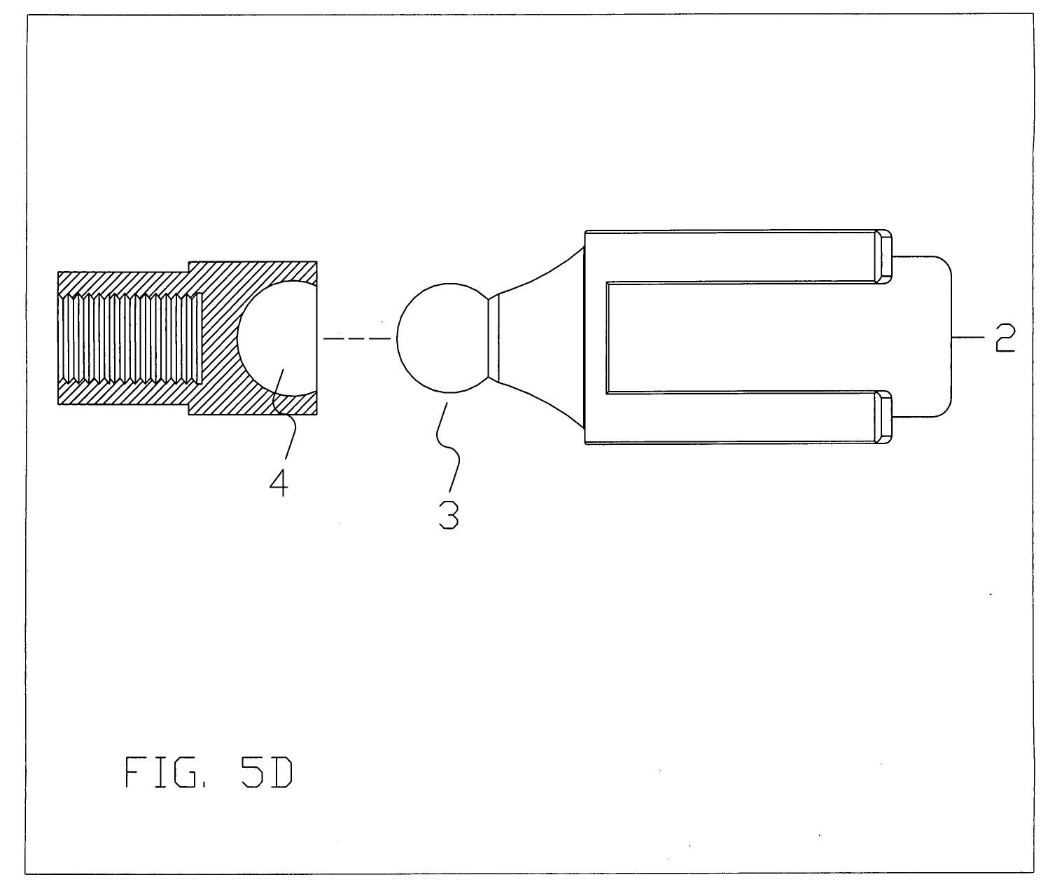

Referring to FIG. 3 (clevis linkage component) and FIG. 4 (ball joint linkage component) both linkage components are transformed into one working linkage component (FIG. 5-5D) to create the present invention.

The present invention borrows from the current designs of both the ball joint (FIG. 4-4C) and the clevis (FIG. 3-3B). Both the spherical body 3 and the spherical cavity 4, borrowed from the ball joint (FIG. 4), are utilized in the present invention (FIG. 5-5D). The clevis boss 2, borrowed from the clevis (FIG. 3), is also utilized in the present invention. These features combined create a unique clevis style linkage component that maintains the ability of rotational/axial movement.

Furthermore FIGS. 5A, 5C, and 5D illustrate the two main components that combine to create the present invention. The main threaded body 6 contains a spherical cavity 4 which will in turn house the spherical structure 3 located on the clevis body. Again this provides the axial and/or rotational capabilities for the present invention. The design maintains a threaded body 6 for attachment to either an actuation or connection point. The design also maintains a standard clevis boss 2 for attachment to either an actuation or connection point.

1. A clevis type linkage for transmitting force with 360 degrees of motion. Comprised of main threaded body which maintains a spherical cavity; clevis body attaches to before said main threaded body through use of spherical shaped structure; threaded body and clevis body integrally formed into single entity therefore encompassing present invention.

2. The main threaded body of claim 1 has female threads for receiving standard thread types encompassing both metric and standard sizes.

3. The main threaded body of claim 1 has a spherical cavity which is utilized in coordination with the clevis body spherical shaped structure of claim 1; spherical cavity within main threaded body houses spherical shaped structure attached to clevis body; spherical cavity of main threaded body combined with spherical shaped structure of clevis body allow for 360 degrees of motion.
